(19) United States
(12) Patent Application Publication
(10) Pub. No.: US 2024/0217415 A1
(43) Pub. Date: Jul. 4, 2024

(54) ARMREST FOR A VEHICLE

(71) Applicant: GRAMMER AG, Ursensollen (DE)

(72) Inventor: Ralph NUSS, Poppenricht (DE)

(21) Appl. No.: 18/242,284

(22) Filed: Sep. 5, 2023

(30) Foreign Application Priority Data
Sep. 9, 2022 (DE) 10 2022 123 013.9

(51) Int. Cl. B60N 2/75

(52) U.S. Cl. CPC B60N 2/767

(57) ABSTRACT

An armrest having a base and an arm support pivotable relative to the base between a first and a second position, and having a locking device, with which the pivoting movement of the arm support relative to the base or relative to a pivoting part that can be pivoted with respect to the base can be locked. The locking device includes two rotatably mounted wheels having first locking surfaces, and a latch which is movable between a latching position and a release position and has second locking surfaces. The first and second locking surfaces are engaged in the latching position and disengaged in the release position. The locking device has first transfer mechanism associated with the wheel and second transfer mechanism associated with the base, with which the arm support can be supported on the base in the latching position in at least two different use positions.

The invention relates to an armrest for a vehicle. For the purposes of the invention, a vehicle may be, for example, a land vehicle, an aircraft or a watercraft.

The armrest comprises a base which can be attached to the vehicle, for example to the bodywork, and an arm support which can be pivoted about a pivot axis. The pivot axis is formed between the base 11 and the support part 12.

Such an arm support is known from DE 10 2019 190 399. The arm support is pivotably mounted on the base. A locking device comprises first adjustment means on the arm support and second adjustment means on a pivoting device, which is likewise pivotably held on the base. The first adjustment means comprise a wheel rotatably mounted on the arm support and lockable with a latch of the locking device. In a latching position of the locking device, the latch is engaged with the wheel, and, in a release position, the latch is disengaged from the wheel.

The pivoting device comprises stop means that interact with stop means of the base. It is thus possible to set the use position of the arm support once the lock has been released. In the locked position, an upward pivot is readily possible, wherein the armrest maintains the set use position when the stops are in contact again after a downward pivot.

In order to ensure the required holding forces of the locking device, a wheel with a diameter was necessary, which resulted in an enlargement of the installation space and was of considerable weight.

It was the object of the invention to make the armrest smaller so that it can be accommodated in a typical arm support or console installation space and still guarantee the required holding force. It was also the object of the invention to reduce the cost and weight of the armrest and to avoid noise when using the armrest.

The object was achieved by an armrest having the features of claim 1.

The armrest comprises a base and an arm support pivotable relative to the base between a first position and a second position in opposite directions about a pivot axis. The arm support is pivotably mounted on the base. The armrest may be, for example, a free armrest provided with a free-end arm support, or it may be, for example, the lid of a console.

With a locking device adjustable between a locking position and a release position, the pivoting movement of the arm support relative to the base or relative to a pivoting part that can be pivoted with respect to the base can be locked in at least one direction. That is to say, according to a first alternative, the arm support in the latching position is not movable relative to the base or relative to the pivoting part in either pivot direction. According to a second alternative, for example, the arm support is freely movable relative to the base in one pivot direction and not movable in the other pivot direction.

The locking device comprises at least one rotatably mounted wheel with first locking surfaces, and at least one latch with second locking surfaces movable between a latching position and a release position. The latch can be used to block rotation of the wheel. In the latching position, the first locking surfaces and second locking surfaces are engaged and block the movement of the wheel, and, in the release position, the locking surfaces are disengaged and the wheel can rotate.

The locking device additionally comprises first transfer means and second transfer means which, in the release position, cause the wheel to rotate when the arm support is pivoted. In the latching position, the first transfer means and second transfer means allow the arm support to be supported on the base and thus allow forces acting on the arm support to be transferred to the base. The transfer means may be formed by any suitable means. For example, the transfer means are formed by friction-fit or frictional engagement means. The first transfer means are in engagement with the second transfer means. For example, the transfer means comprise meshing teeth.

The first transfer means are associated with the wheel and are rotationally connected to the wheel. The first transfer means can be assigned—together with the wheel—to the arm support or the base. The second transfer means are assigned to the respective other component of the base and arm support. For example, the wheel with the first transfer means is held on the arm support and the second transfer means are held on the base. According to an alternative, the wheel with the first transfer means is held on the base and the second transfer means are held on the arm support.

The arm support comprises at least two wheels. In this way it is possible to reduce the diameter of the wheel and still achieve the same holding force in the latching position. Furthermore, it is possible to increase the holding force of the arm support. Furthermore, the requirements on the material of the wheel are lower. For example, the wheel can be made of a plastic, a composite plastic or diecast zinc. The centrifugal mass can also be reduced in this way. With a large centrifugal mass, a jolt occurs at the end of the adjustment movement due to the mass inertia. This can be reduced in the armrest according to the invention by using lighter materials, and noise can be reduced. When using plastic, the construction can also be simplified, as additional bearing bushes, for example, are not required.

According to one embodiment, the second transfer means are fixedly connected to the base or to the arm support. In this case, the locking device is moved into the release position for each movement of the arm support, for example, or, according to an alternative, a directional freewheel is formed for the upward pivot. This embodiment is constructively less complex.

The second transfer means are for example associated with at least one pivoting part that can pivot about the pivot axis. Irrespective of whether the wheels with the first transfer means are associated with the arm support or the base, the second transfer means, comprising for example a toothing, can be formed on a pivoting part which can be pivoted about the pivot axis. The pivoting part is supported, for example in the basic position with respect to a pivoting device, on a stop and is freely movable with respect to an opposite pivot direction in the direction of a non-use position. The pivoting part is loaded, for example by spring means, against the base-fixed or armrest-fixed stop. If the pivoting part is designed as an arm, no large distance has to be bridged to ensure the engagement of first transfer means and second transfer means. This embodiment allows the arm support to always pivot freely upwards without first moving the locking device into the release position.

According to one embodiment, a pivoting part with second transfer means may be associated with and may cooperate with each wheel. According to an alternative, several pivoting parts cooperate with one wheel, or several wheels cooperate with one pivoting part.

At least one wheel has first transfer means and is rotationally connected to the first transfer means. For example, each wheel has first transfer means. According to an alternative design, several wheels have first transfer means together. The first transfer means are then connected to several wheels.

According to one embodiment, at least two pivoting parts are connected to each other and move synchronously. This ensures that the arm support is not twisted. In addition, the stability of the pivoting parts is increased.

The pivoting elements (18a, 18b) and the pivoting parts (25a, 25b) are for example arranged nested in relation to each other. With this embodiment, installation space can be saved and the feature has a visually advantageous effect on the armrest. This is because—if there are for example two pivoting elements and two pivoting parts—the user can only recognize one pair of them.

The wheels are for example rotationally connected to each other and move synchronously. If, for example, first transfer means are only formed once for several wheels, the movement can be transferred to several or to all wheels, for example by means of a rotary connection. In this way, the construction can be made simpler.

For example, a first wheel is arranged on a first side support and a second wheel on a second side support of the arm support. As the wheel is sometimes subjected to high holding forces, it must have a stable bearing. The side supports of the arm support can take over this bearing as stable main supports of the arm support. In addition, the wheels can be at least partially concealed by the side supports. The side supports also provide protection for the wheels so that their function is not impaired.

The first wheel and/or the second wheel is for example designed as a multiple wheel with several locking surfaces. For example, the multiple wheel can be designed as a double, triple or quadruple wheel, wherein the multiple wheel has a corresponding number of locking surfaces that interact with locking surfaces of one or more latches. For example, a latch in this case has a corresponding number of locking surfaces as the multiple wheel. The multiple wheel can be produced, for example, as one component or as an assembly and can be stored in the armrest or in the base. This simplifies production and reduces costs.

A locking surface of at least one wheel is associated with a locking surface of at least one latch, wherein the holding force in the latching position is absorbed by all locking surfaces. As already mentioned above, a latch can have only one locking surface or several locking surfaces and a wheel can have only one locking surface or—in the case of a multiple wheel—several locking surfaces. In any case, a pair of locking surfaces consisting of a first locking surface and a second locking surface always cooperate with one another.

The locking surfaces are formed, for example, by friction surfaces or wedge surfaces. In this way, stepless locking is possible and, in particular when wedge surfaces are used, the arm support can be held securely in the locking position without the use of high normal forces.

The wheel is made, for example, of plastic, a plastic composite or diecast zinc. The solution according to the invention allows the selection of a less stable material for the wheel. For example the aforementioned materials cause reasonable costs, but are sufficient for the transfer of forces. As already mentioned above, a lightweight material has the advantage that the weight of the armrest is low and the wheel develops a low inertia force.

The first transfer means comprise, for example, a toothing which engages with a toothing of the second transfer means. With a toothing, an interlocking transfer of the movement of the arm support to the wheel is possible. Cooperating toothings represent an easily formed and functionally reliable form of movement transfer.

Exemplary embodiments of the invention are described in the following figure description, also with reference to the drawings. For the sake of clarity, identical or comparable parts or elements or regions are designated by the same reference signs, sometimes with the addition of small letters—even where different exemplary embodiments are concerned.

Features described only in relation to one exemplary embodiment may also be provided in any other exemplary embodiment of the invention within the scope of the invention. Such modified exemplary embodiments—even if not shown in the drawings—are included by the invention.

All disclosed features are, per se, essential to the invention. The disclosure of the application hereby also includes the full disclosure content of the cited publications and the described prior art devices, also for the purpose of including individual or several features of these documents in one or several claims of the present application.

The figures show:

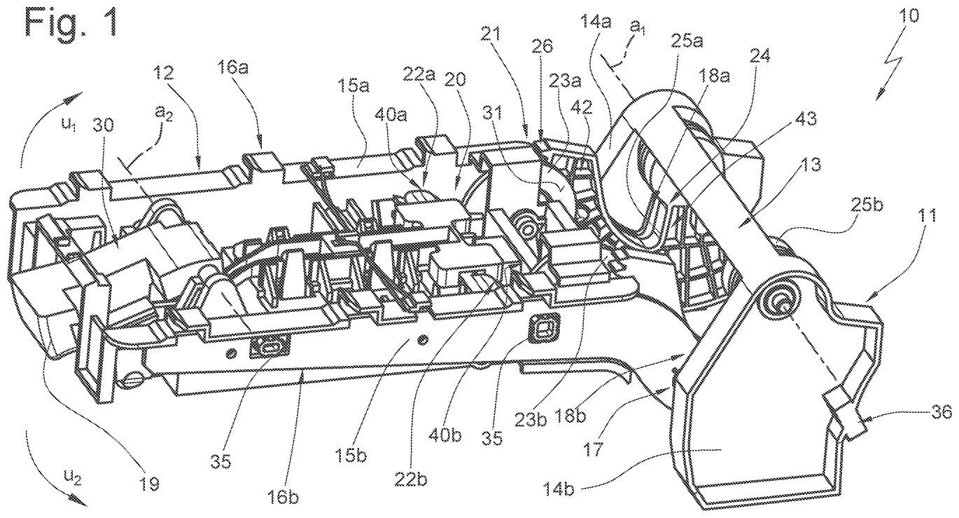

FIG. 1 a perspective view of the armrest diagonally from above,

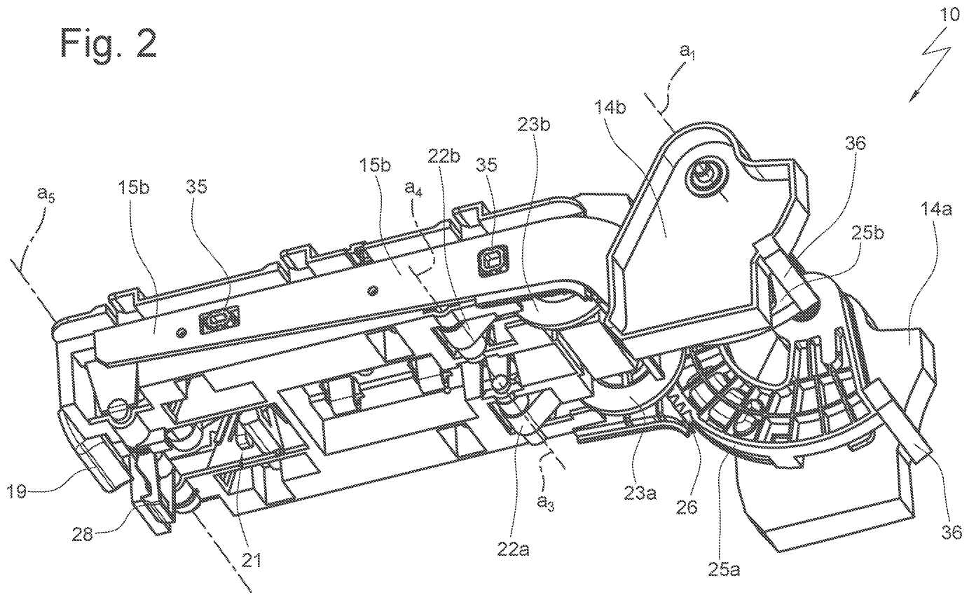

FIG. 2 a perspective view of the armrest diagonally from below,

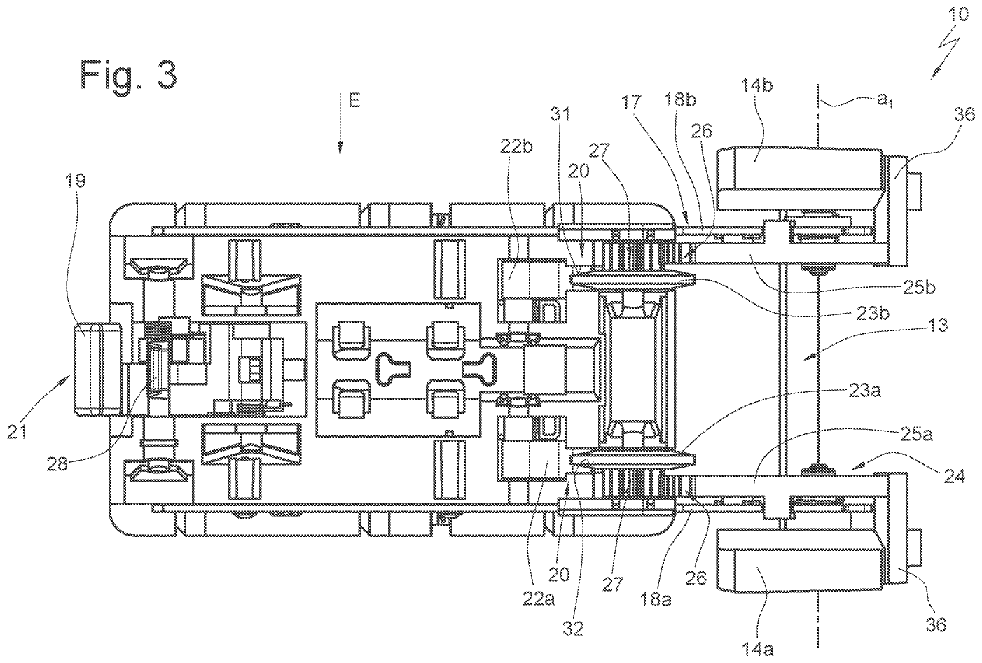

FIG. 3 a bottom view of the armrest,

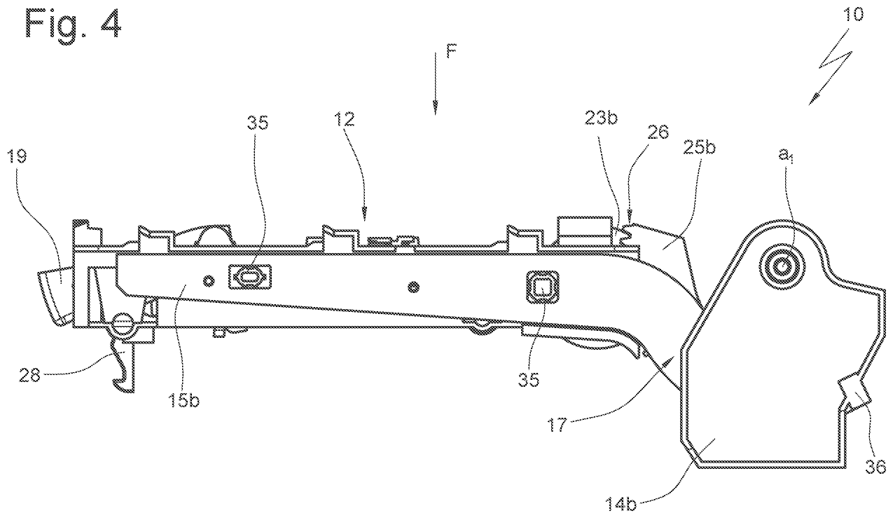

FIG. 4 a side view according to view arrow E in FIG. 3,

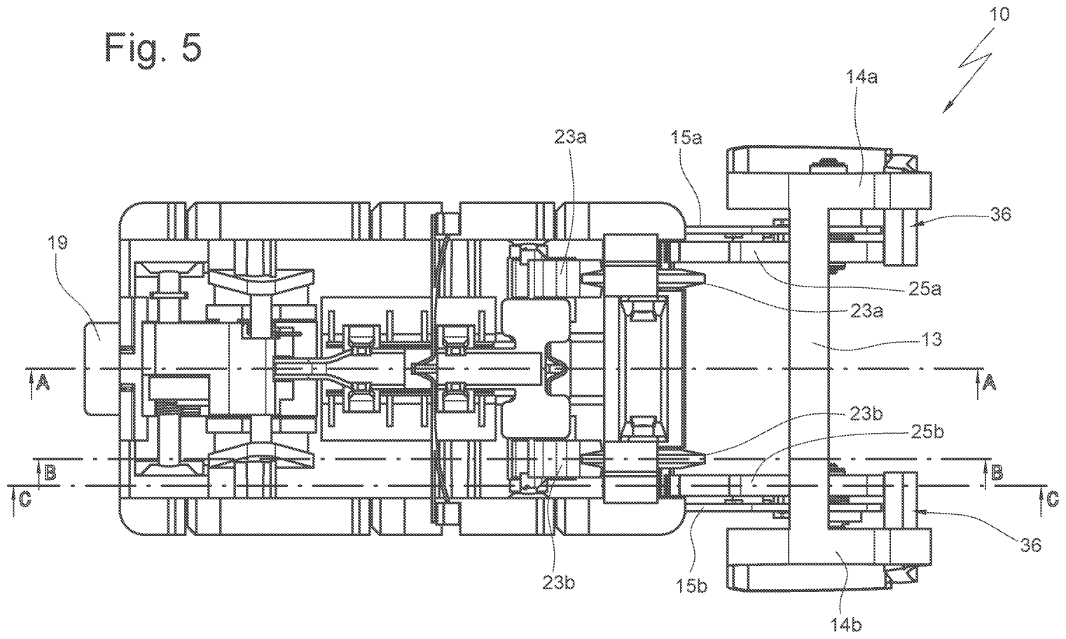

FIG. 5 a plan view according to view arrow F in FIG. 4,

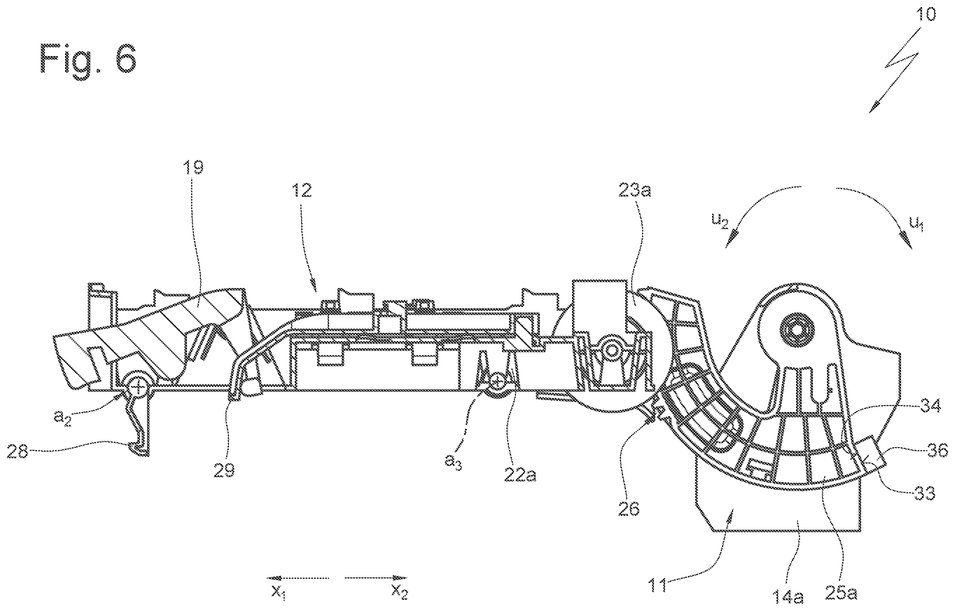

FIG. 6 a sectional view according to line of section A-A in FIG. 5,

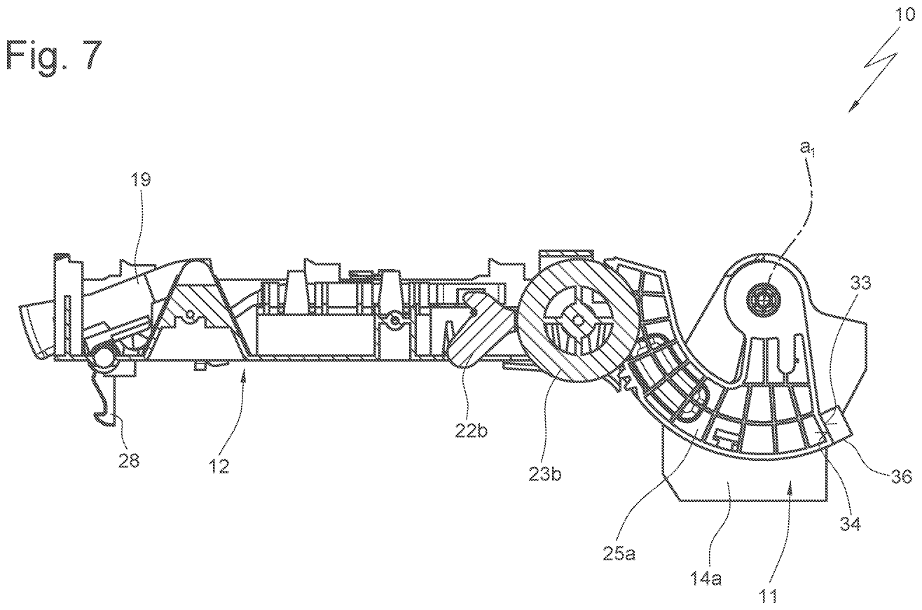

FIG. 7 a sectional view according to line of section B-B in FIG. 5,

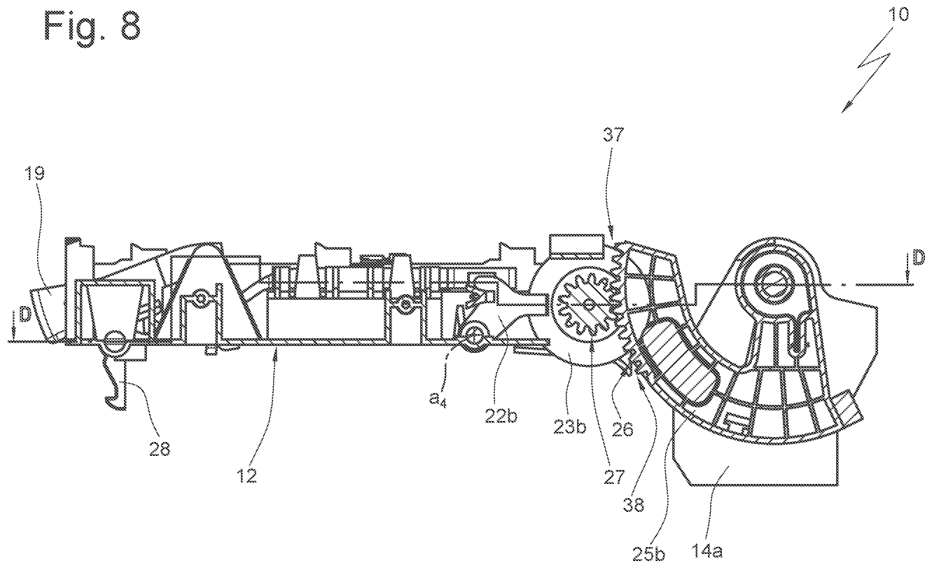

FIG. 8 a sectional view according to line of section C-C in FIG. 5,

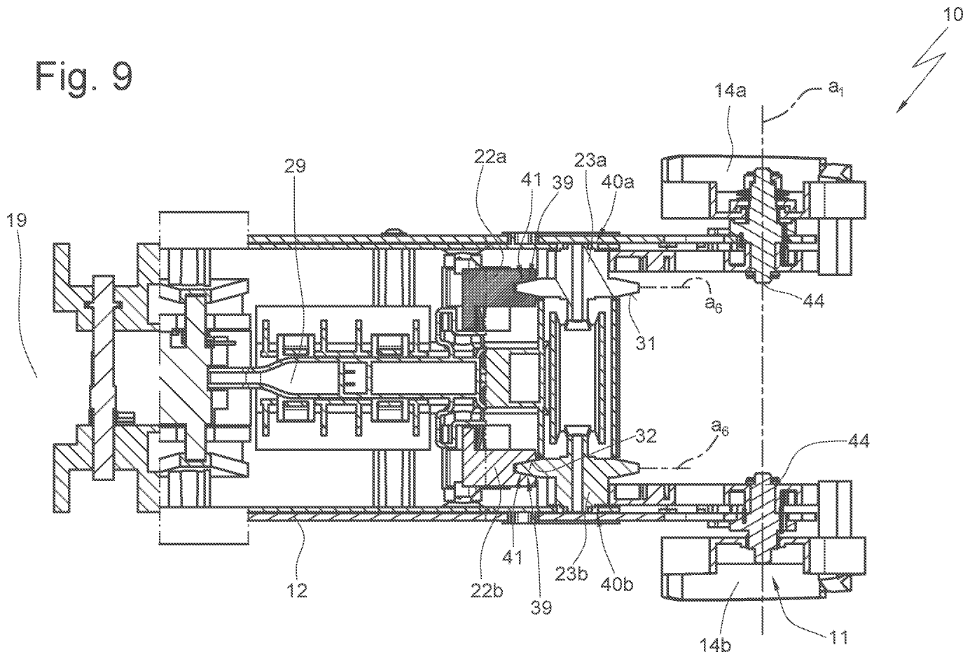

FIG. 9 a sectional view according to line of section D-D in FIG. 8,

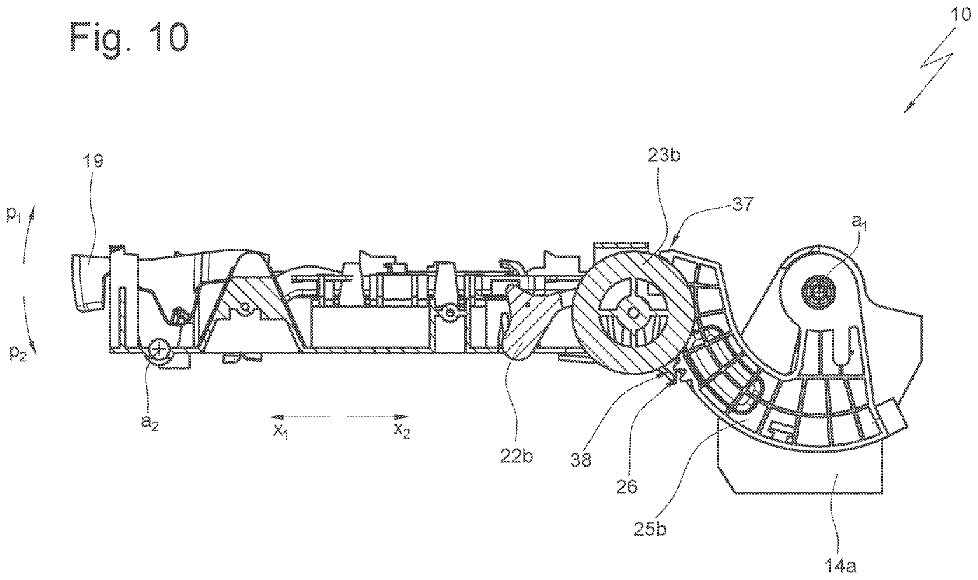

FIG. 10 a sectional view according to FIG. 7, wherein the locking device is in the release position,

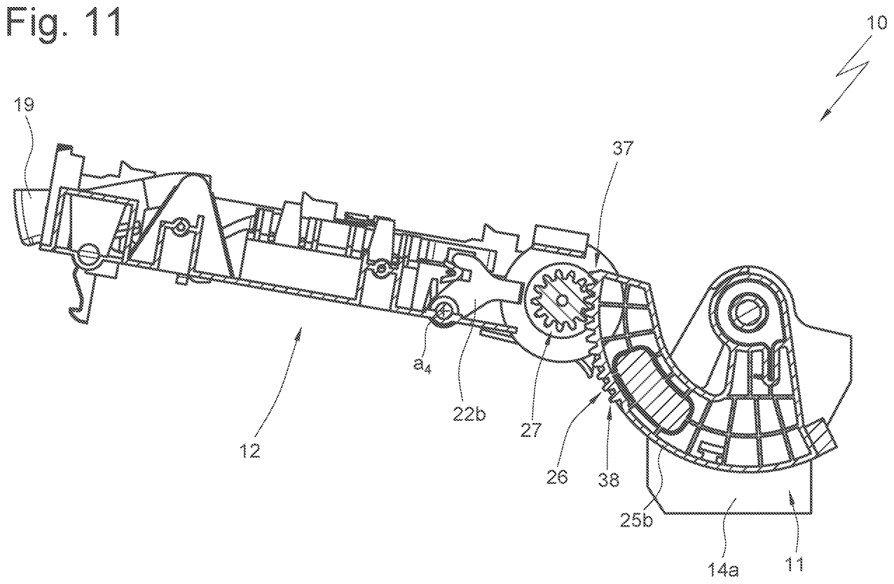

FIG. 11 a sectional view according to FIG. 8, wherein the toothing of the wheel is engaged with an upper region of the toothing of the pivoting part and thus a higher use position of the arm support is set,

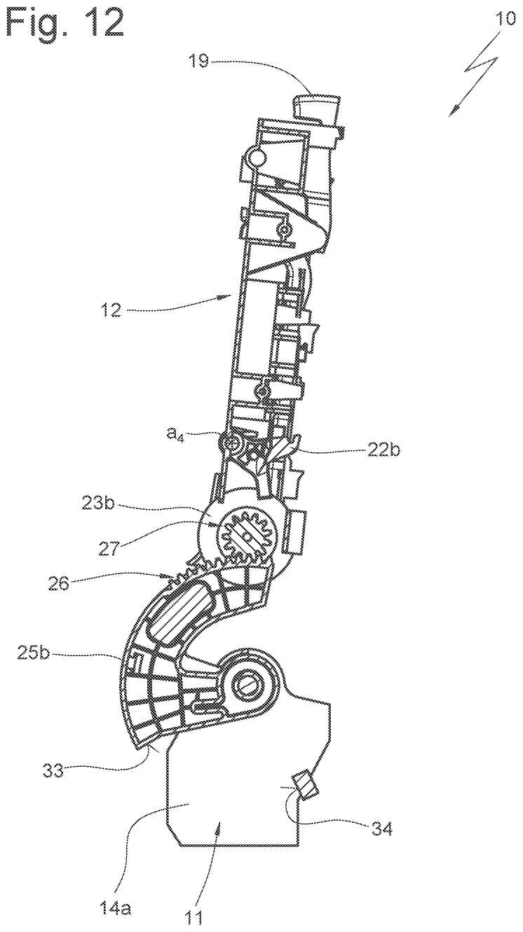

FIG. 12 a sectional view according to FIG. 11, wherein the arm support is arranged in a non-use position, and

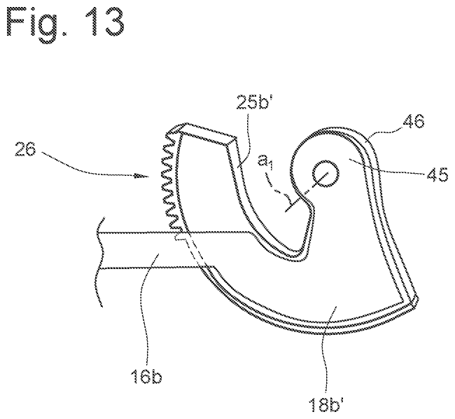

FIG. 13 a perspective view of a second exemplary embodiment of the pivoting element and pivoting part.

An armrest as a whole is designated by the reference sign 10 in the figures.

According to FIG. 1, the armrest 10 comprises a base 11 and an arm support 12 which can be pivoted about a geometric pivot axis a1. The base 11 is formed by two retaining elements 14a and 14b which are connected by means of a web 13 and can be fastened directly or indirectly to the vehicle body.

Housing parts and upholstery parts of the armrest 10 are not shown in the figures for the sake of clarity. The arm support 12 comprises two supports 15a and 15b, which form the side regions 16a and 16b of the arm support. For stabilization, the supports 15a and 15b are connected to each other with bars 35. The arm support 12 is pivotably held on the base 11 by a pivot mechanism 17. In this exemplary embodiment, the pivot mechanism 17 comprises two pivoting elements 18a and 18b, which are integrally molded on the supports 15a and 15b and which are pivotably connected to the retaining elements 14a and 14b respectively. With this mounting, the arm support 12 can be pivoted in the directions u1 and u2 about the pivot axis a1, wherein the end positions are delimited by stops. The upper end position of the arm support 12 is formed by the contact of the pivoting element 18a or 18b with the web 13.

In FIGS. 1 to 3, parts of a locking device 20 can also be seen. The locking device 20 can be moved between a locking position and a release position by means of a movable actuator 19 of an actuating device 30 of the locking device 20, which actuator can be pivoted here about a pivot axis a2. The locking device 20 is spring-loaded into the locking position.

The actuating device 30 transfers the movement of the actuator 19 to two latches 22a and 22b (see FIG. 3), which also belong to the locking device 20. The latch 22a cooperates with a wheel 23a to form therewith a latch device 40a, and the latch 22b interacts with a wheel 23b to form a latch device 40b. Each wheel 23a and 23b is mounted on one of the supports 15a and 15b respectively. However, the mounting can also be provided in another way. Each latch 22a and 22b is in a clamping relationship with the wheel 23a and 23b respectively in the latching position, such that rotation of the wheel 23a and 23b, respectively, is blocked.

A pivot device 24 is part of a transfer device 21 and comprises two pivoting parts 25a and 25b pivotable about the pivot axis a1. The pivoting parts 25a and 25b as well as the pivoting elements 18a and 18b of the supports 15a and 15b are shaped in the form of a circular portion, wherein the circular portion-like region 42 has a radial extension 43 to the pivot axis a1. In this way, the pivot bearing can be kept largely invisible to the user.

Each pivoting part 25a and 25b has a toothing 26 which engage with a toothing 27 which is not visible in FIG. 1. One of the toothings 27 is connected to the wheel 23a for conjoint rotation and another of the toothings 27 is connected to the wheel 23b for conjoint rotation. The pivoting parts 25a and 25b are loaded, for example by a spring not shown, in the direction of rotation u2 in contact with a stop 36.

In FIG. 1 it can be seen that the actuator 19 is rotatably mounted about the pivot axis a2. The latches 22a and 22b are mounted pivotably about pivot axes a3 and a4. In FIG. 2, a locking element 28 can be seen which can be pivoted about a pivot axis a5 and with which the arm support 12—in this exemplary embodiment in the form of a lid of a console—can be locked in the lower use position on a counter-locking device of the console which is not shown.

In FIG. 3, the toothings 27 rotatably connected to the wheels 23a and 23b can be seen, which are in engagement with the toothings 26 of the pivoting parts 25a and 25b.

According to FIG. 4, it is clear that the arm support 12 is arranged in an approximately horizontal position, which is a use position.

According to FIG. 6, the actuator 19 is in operative connection with an actuating element 29 of the actuating device 30, in such a way that when the actuator 19 is rotated in direction p1, the actuating element 29 is moved in direction x1, wherein it pivots the latches 22a and 22b into the release position against the spring force of springs, not shown, which load the latches 22a and 22b into the latching position. When the actuator 19 is released, the actuating element 29 is therefore pivoted back in the direction x2 and the actuator 19 is pivoted back in the direction p2 into the starting position according to FIG. 6.

In addition, FIG. 6 shows that, in the use position, the pivoting device 24 has contact surfaces 33 (these are formed on the pivoting parts 25a and 25b in this example), which are in contact with stop surfaces 34 of the stop 36 of the base 11. In this case, contact surfaces 33 of the pivoting parts 25a and 25b are in contact with stop surfaces 34 of the retaining elements 14a and 14b. The contact can be released by simply moving the arm support in the direction u1, wherein the pivot parts 25a and 25b pivot relative to the retaining elements 14a and 14b of the base 11. The relative position between the arm support 12 and the pivoting device 24—here designed as pivoting parts 25a and 25b—does not change.

In FIG. 7, in the latching position the engagement of second locking surfaces 41 of the latches 22a and 22b with first locking surfaces 39 of the wheels 23a and 23b in the latching position can be seen (in FIG. 7, only the latch 22b and the wheel 23b can be seen, but the other latch 22a is also engaged with the wheel 23a).

According to FIG. 8, the toothing 27 engages with the toothing 26 in such a way that the arm support 12 is in an approximately horizontal position. The toothing 27 is in contact for example with a central region of the toothing 26.

FIG. 9 shows the cooperation of the latch 22a with the wheel 23a and of the latch 22b with the wheel 23b. The first locking surfaces 39 of the wheels 23a and 23b and the second locking surfaces 41 of the latches 22a and 22b are designed as wedge surfaces. The angles of wedge outer surfaces 31 of the wheel 23a and 23b and wedge inner surfaces 32 of the latch 22a and 22b relative to a central axis a6 of each wheel 23a and 23b is small, for example between 10° and 15°, so that when the latch 22a or 22b is moved to the latching position, the wheels 23a and 23b are blocked.

In FIG. 9, it can be seen that the pivot axis a1 is physically formed by axle elements 44, with which the arm support 12 and the pivoting parts 25a and 25b are pivotably mounted on the base 11.

In FIG. 10, the locking device 20 is shown in the release position, wherein the latches 23a and 23b are disengaged or positioned in relation to the respective wheels 22a and 22b such that the wheel 23a and the wheel 23b are not locked. The toothing 27 can roll on the toothing 26 in the release position with rotation of the wheels 23a and 23b, wherein the relative movement of the first pivoting device 17 in relation to the second pivoting device 24 and hence the position of the arm support 12 is changed.

Comparing FIGS. 11 and 8, it is clear that the use position has been changed. The locking device 20 is in the latching position, which is automatically set by spring loading of the latches 22a and 22b when the actuator 19 is relieved. The toothing 27 of the transfer means 21 is in engagement with a first end region 37 of the toothing 26 of the transfer means 21.

According to FIG. 12, the arm support 12 has been pivoted into the upper end position, wherein the relative position of the pivoting devices 17 and 24 in relation to the relative position according to FIG. 11 is unchanged. The arm support 12 can easily be pivoted against the force of a spring device, not shown, in the direction u1 into the non-use position as shown in FIG. 12, wherein the contact surface 33 and the stop surface 34 detach from each other. From the non-use position, the arm support 12 can be pivoted back in the direction u2 into the unchanged use position, in which the contact surface 33 and the stop surface 34 are in contact.

A second exemplary embodiment differs from the first embodiment example only with regard to the design of the pivoting parts 25a and 25b as well as the pivoting elements 18a and 18b, wherein the exemplary embodiment is explained by way of example with reference to the pivoting part 25b′ and the pivoting element 18b′. In the first exemplary embodiment, the pivoting parts 25a and 25b were formed axially offset from the pivoting elements 18a and 18b.

According to FIG. 13, the pivoting element 18b′ according to the second exemplary embodiment is accommodated in a nested manner to form a housing-like pivoting part 25b′. The pivoting element 18a′, which is not shown, is mounted in the same way, nested in relation to the pivoting part 25a′, which is also not shown. A bearing head 45 of the respective pivoting element 18a′ or 18b′ is formed radially within a bearing structure 46 of the pivoting part 25a′ or 25b′. In other words, the bearing structure is mounted radially outside on the bearing head. In this way, installation space can be saved and the appearance of the armrest 10 can be improved.

The function of the armrest 10 is explained below. According to FIG. 8, the arm support 12 is in an approximately horizontal position. The contact surfaces 33 of the pivoting parts 25a and 25b are in contact with the stop surfaces 34 of the retaining elements 14 of the base 11. The latches 22a and 22b are arranged in the latching position. Therefore, the wheels 23a and 23b cannot rotate. The toothings 27 of the wheels 23a and 23b are in engagement with the toothings 26 of the pivoting parts 25a and 25b. A relative movement of the first pivoting device 17 with respect to the second pivoting device 24 is thus prevented.

From the use position according to FIG. 8, the arm support 12 can be readily pivoted in the direction u1 into the non-use position according to FIG. 12, wherein the relative position between the first pivoting device 17 and the second pivoting device 24 is maintained. Due to the fact that the locking device 20 is in the latching position, a relative movement of the pivoting devices 17 and 24 is prevented. In this case, the contact surfaces 33 come out of contact with the stop surfaces 34. From the non-use position, the arm support 12 can be swiveled again in the direction u2 into the use position according to FIG. 8.

If the use position is to be changed, the locking device 20 is moved into the release position by means of the actuator 19 of the actuating device 30. This is done by pivoting the actuator 19 in direction p1 according to FIG. 10, wherein the actuating element 29 moves in direction x1 and moves the latches 22a and 22b into the release position from the clamping relationship to the wheels 23a and 23b. The wheels 23a and 23b are then free to rotate, allowing the toothings 27 to roll on the toothings 26 and the arm support 12 to pivot in the direction u1 or u2 relative to the pivoting parts 25a and 25b. In the process, the contact surfaces 33 of the pivoting parts 25a and 25b are loaded against and held in contact with the stop surfaces 34 by a spring device, not shown.

As soon as the desired use position has been set, for example a use position in which, according to FIG. 11, the toothing 27 has been moved to a first end region 37 of the toothing 26, the actuator 19 can be relieved, whereupon the actuating element 29 moves in the direction x2 due to spring force, whereupon the actuator pivots in the direction p2 and whereupon the latches 22a and 22b are moved into the latching position. A relative movement of the first pivoting device 17 and the second pivoting device 24 is then no longer possible in the newly set use position.

Of course, the use position could, alternatively, also have been changed such that the toothing 27 moves from the position shown according to FIG. 8 into contact with a lower end region 38 of the toothing 26 or into an intermediate position, wherein these relative positions are not shown. From any use position set in this way, the arm support 12 can be moved—without adjustment of the locking device 20—into the non-use position according to FIG. 12.

An essential feature of the invention is that a force acting on the arm support 12, which causes a moment in the direction u2 in the arm support 12, is transferred to the base 11 via the first latch device 40a, comprising the latch 22a and the wheel 23a, and via the second latch device 40b, comprising the latch 22b and the wheel 23b, via the transfer means 26 and 27, via the pivoting parts 25a and 25b and via the surfaces 33 and 34. As a result, the holding force between the latch 22a and the wheel 23a and the latch 22b and the wheel 23b is halved. It is therefore possible to design the wheels 23a and 23b with a smaller diameter.

Furthermore, it is possible to use a less solid material, such as plastic or diecast zinc. Another advantage is that, due to the possibility of forming the wheels 23a and 23b with a lower mass, the weight of the armrest 10 is reduced. Furthermore, the centrifugal mass of the wheels 23a and 23b is also lower, so that when the wheels 23a and 23b stop, there is no noticeable jolt in the armrest, which would be the case with a larger centrifugal mass.

Alternatively to this example, for example, more than two, for example three, four, five or six wheels, each cooperating with a latch and forming further latch devices, could be used to transfer the load of the arm support 12 to the base 11 in the latching position, wherein each individual latch device experiences a lesser load. In other words, each individual latch device must hold a smaller locking force between the latch and the wheel without slipping.

It would also be possible to form wheel and latch components which are provided with several locking surfaces. For example, such a wheel component could have several locking surfaces in a direction parallel to the axis of rotation and a bolt could be equipped with several locking surfaces in a complementary arrangement.

1-14. (canceled)

15. An armrest, comprising: a base; an arm support pivotable relative to the base between a first and a second position about a pivot axis; and a locking device configured to lock pivoting movement of the arm support relative to the base or relative to at least one pivoting part that is pivotable relative to the base about the pivot axis in at least one direction, wherein the locking device comprises at least two wheels that are rotatably mounted on the arm rest or on the base and have first locking surfaces, and at least one latch that is movable between a latching position and a release position and has second locking surfaces, the first and second locking surfaces being engaged in the latching position and disengaged in the release position, wherein the locking device further comprises first transfer means associated with the wheels and second transfer means associated with the base or the arm support, by which the arm support is supported on the base in the latching position in at least two different use positions.

16. The armrest according to claim 15, wherein the second transfer means are immovably held on the arm support or the base.

17. The armrest according to claim 15, wherein the second transfer means are arranged on the at least one pivoting part that is pivotable about the pivot axis.

18. The armrest according to claim 17, wherein the at least one pivoting part includes at least two pivoting parts and each of the wheels is associated with a respective one of the pivoting parts with second transfer means.

19. The armrest according to claim 18, wherein at least two pivoting parts are connected to each other and move synchronously.

20. The armrest according to claim 18, further comprising pivoting elements associated with the arm support so as to form a pivot joint with the base, the pivoting parts being arranged nested in relation to one another.

21. The armrest according to claim 15, wherein the at least two wheels are interconnected and move synchronously.

22. The armrest according to claim 15, wherein the arm support has a first side support and a second side support, a first of the wheels being arranged on the first side support and a second of the wheels being arranged on the second side support.

23. The armrest according to claim 22, wherein the first wheel and/or the second wheel is formed as a multiple wheel with several of the first locking surfaces.

24. The armrest according to claim 15, wherein the first locking surfaces and the second locking surfaces are formed by friction surfaces or wedge surfaces.

25. The armrest according to claim 15, wherein each of the first locking surfaces of the at least two wheels is associated with a second locking surface of the at least one latch so as to form a latch device.

26. The armrest according to claim 15, wherein the wheels are made of plastic, a plastics composite or diecast zinc.

27. The armrest according to claim 15, wherein the second transfer means includes a toothing and the first transfer means includes a toothing that engages with the toothing of the second transfer means.

28. The armrest according to claim 15, wherein the wheels arrange to transfer a force acting on the arm support in the latching position to the base.
